(19) United States
(12) Patent Application Publication
(10) Pub. No.: US 2006/0054432 A1
(43) Pub. Date: Mar. 16, 2006

(54) Anti-shock system

(76) Inventors: Yu-Yen Chiu, Taoyuan Hsien (TW); Jui-Chung Peng, Hsinchu (TW); Wei-Li Yi, Hua-Lian County (TW); George C. Yao, Tainan City (TW)

Correspondence Address: BIRCH STEWART KOLASCH & BIRCH, PO BOX 747, FALLS CHURCH, VA, 22040-0747, US

(21) Appl. No.: 10/941,977

(22) Filed: Sep. 16, 2004

(51) Int. Cl. F16F 15/03

(52) U.S. Cl. 188/267

(57) ABSTRACT

An anti-shock system for a machine. A first movable device is disposed between the machine and a surface. When vibration is transmitted to the machine from the surface, the first movable device releases the machine, which slides along the base to prevent vibration from transmitted to the machine.

### BACKGROUND OF THE INVENTION

1. Field of the Invention

The present invention relates to an anti-shock system, and in particular to an anti-shock system that protects semiconductor fabrication equipment.

2. Description of the Related Art

FIG. 1 shows a conventional anti-shock structure that protects semiconductor fabrication equipment. A base 20 is fixed under a tool 10, adhered to surface 30 by adhesive 21.

While base 20 absorbs vibration, it cannot fully absorb vibration from major discordances, whereby machine 10 may be damaged.

U.S. Pub. App. No. 20030122681 discloses a method and a device in which during earthquake or other agitation, vibration is transmitted to the machine 10, at which point, a controller in the machine 10 senses the vibration and shuts down the machine 10 to prevent product damage, however, damage may have already occurred prior to the emergency shutdown.

### SUMMARY OF THE INVENTION

The anti-shock system of the present invention comprises a first movable device disposed between the machine and a surface. When vibration is transmitted to the machine from the surface, the first movable device releases the machine, such that the machine slides on the base to prevent the vibration from transmission thereto.

The first movable device is a magnet, preferably an electromagnet.

The anti-shock system also comprises an anti-shock controller, coupled to a machine controller. When the machine controller shuts down the machine in response to vibration, the anti-shock controller directs the first movable device to release the machine.

The anti-shock system further comprises a base disposed between the first movable device and the machine, a damper, and spring, disposed between the machine and a fixing mechanism, and a second movable device to guide the path of the machine.

The damper and the spring are disposed on a side of the machine. The second movable device is disposed on another side.

### BRIEF DESCRIPTION OF THE DRAWINGS

The present invention can be more fully understood by reading the subsequent detailed description and examples with references made to the accompanying drawings, wherein:

FIG. 1 shows a conventional anti-shock structure;

FIG. 2 is a side view of the anti-shock system of the present invention;

FIG. 3 is a top view of the anti-shock system of the present invention;

FIG. 4 is a block diagram of the control circuit of the anti-shock system of the present invention;

FIG. 5 shows the anti-shock system of the present invention utilized in a factory;

FIG. 6 shows the elements of the present invention disposed under a floor surface.

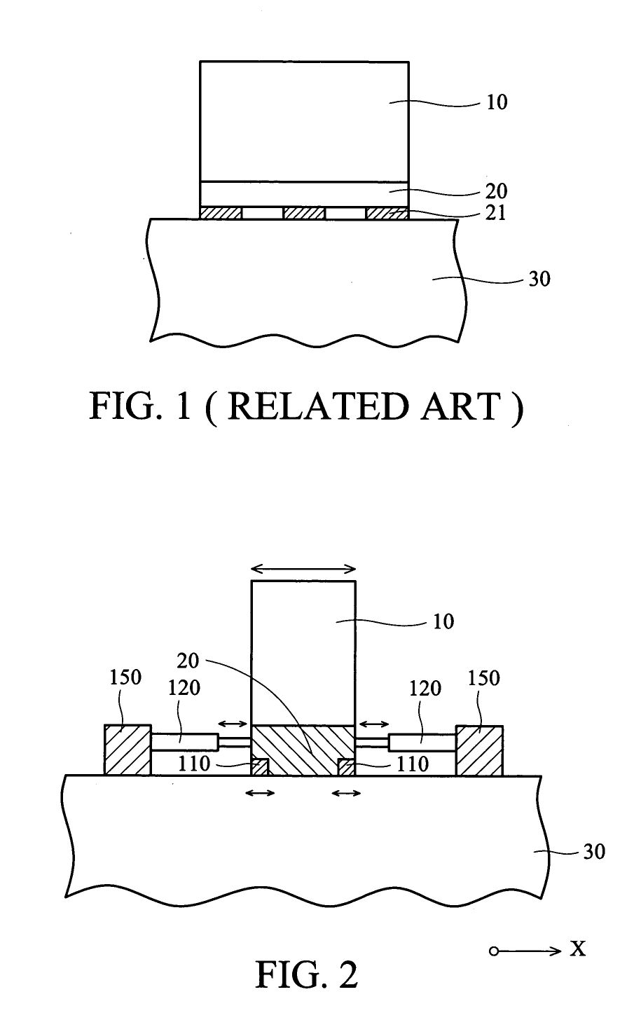

### DETAILED DESCRIPTION OF THE INVENTION

### First Embodiment

As shown in FIG. 2, the anti-shock system of the present invention comprises a base 20, first movable devices 110, dampers 120, and fixed mechanisms 150. A machine 10 is disposed on the base 20. The first movable devices 110 are disposed between the base 20 and a surface 30. The dampers 120 are disposed between the base 20 and the fixed mechanisms 150.

The first movable device 110 is a magnet, preferably an electromagnet, attached to the base 20, which is of metal.

In normal operation, the first movable device 110 fixes the machine 10 on the surface 30. When vibration is transmitted to the machine 10 from the surface 30, the first movable device 110 releases the machine 10, such that the machine 10 slides along the surface 30 to prevent vibration from transmission thereto. As well, the dampers 120 are compressed by the motion, absorbing vibration.

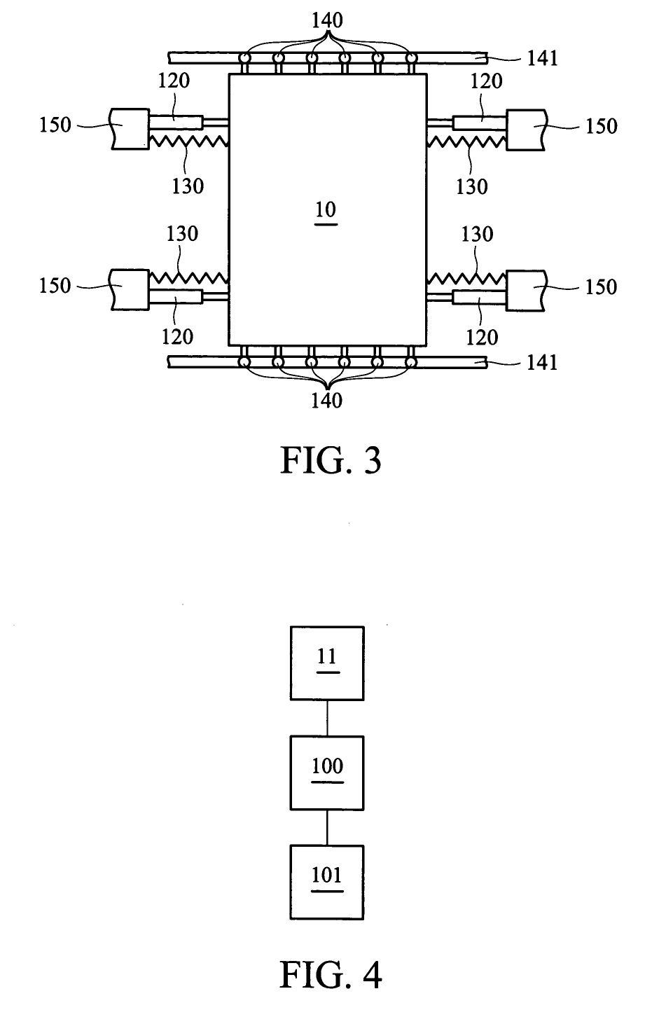

As shown in FIG. 3, the anti-shock system of the present invention further comprises springs 130 and second movable devices 140. The springs 130 are disposed between the base 20 and the fixed mechanism 150. The second movable devices 140 are disposed on the base 20. The second movable devices 140 roll in the tracks 141 to guide the machine 10's path.

When vibration reaches the machine 10, the second movable devices 140 define the machine 10 moving on the x-axis on the surface 30. The machine 10 pushes the dampers 120 and the springs 130. The dampers 120 absorb vibration and the springs 130 prevent the machine 10 from colliding with other elements. As well, springs 130 reciprocate movement of machine 10 between the fixed mechanisms 150, such that vibration is sufficiently absorbed by the dampers 120.

FIG. 4 is a block diagram of the control circuit of the anti-shock system which further comprises a anti-shock controller 100. The anti-shock controller 100 is coupled to a machine controller 11 of the machine 10. When the machine controller 11 shuts down the machine 10 in response to vibration, the anti-shock controller 100 trips a first movable device switch 101 to release the machine 10.

The base 20 can be reduced to simplify the anti-shock system, wherein the first movable devices 110, the second movable devices 140, the dampers 120, the springs 130 are disposed on the machine 10.

### Second Embodiment

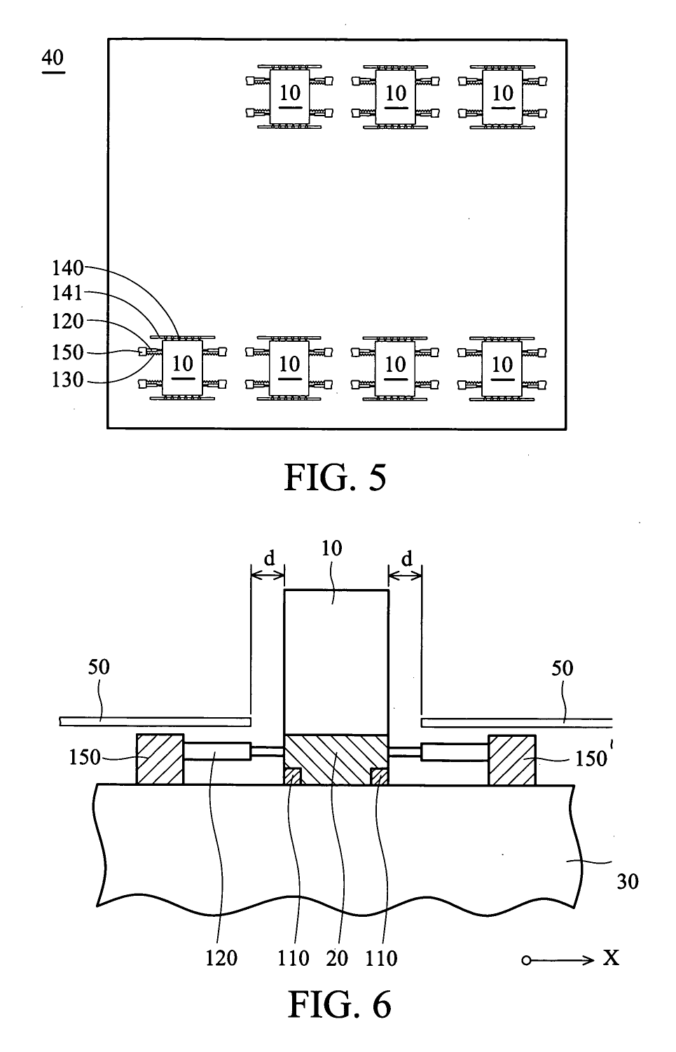

FIG. 5 shows the anti-shock system of the present invention utilized in a factory environment 40. Dampers 120, springs 130, second movable devices 140, tracts 141 and fixed mechanisms 150 are disposed around a machine 10.

A detailed structure of the anti-shock system is illustrated as follows.

As shown in FIG. 2, the anti-shock system of the present invention comprises a base 20, first movable devices 110, dampers 120 and fixed mechanisms 150. A machine 10 is disposed on the base 20. The first movable devices 110 are disposed between the base 20 and a surface 30. The dampers 120 are disposed between the base 20 and the fixed mechanisms 150.

The first movable device 110 is a magnet, preferably an electromagnet, attached to the base 20, which is of metal.

In normal operation, the first movable device 110 fixes the machine 10 on the surface 30. When vibration is transmitted to the machine 10 from the surface 30, the first movable device 110 releases the machine 10, such that the machine 10 slides along the surface 30 to prevent vibration from transmission thereto. As well, the dampers 120 are compressed by the motion, absorbing vibration.

As shown in FIG. 3, the anti-shock system of the present invention further comprises springs 130 and second movable devices 140. The springs 130 are disposed between the base 20 and the fixed mechanism 150. The second movable devices 140 are disposed on the base 20. The second movable devices 140 roll in the tracks 141 to guide the machine 10's path.

When vibration reaches the machine 10, the second movable devices 140 define the machine 10 moving on the x-axis on the surface 30. The machine 10 pushes the dampers 120 and the springs 130. The dampers 120 absorb vibration and the springs 130 prevent the machine 10 from colliding with other elements. As well, springs 130 reciprocate movement of machine 10 between the fixed mechanisms 150, such that vibration is sufficiently absorbed by the dampers 120.

FIG. 4 is a block diagram of the control circuit of the anti-shock system which further comprising an anti-shock controller 100. The anti-shock controller 100 is coupled to a machine controller 11 of the machine 10. When the machine controller 11 shuts down the machine 10 in response to vibration, the anti-shock controller 100 trips a first movable device switch 101 to release the machine 10.

The base 20 can be simplified, wherein the first movable devices 110, the second movable devices 140, the dampers 120, the springs 130 are disposed on the machine 10.

As shown in FIG. 5, the machine 10 comprises two long side surfaces and two short side surfaces. The dampers 120 and the springs 130 can be located at and perpendicular to the long side surfaces. The second movable devices 140 can be located at the short side surfaces.

As shown in FIG. 6, when the anti-shock system is utilized in the factory environment 40, the first movable devices 110, the second movable devices 140, the dampers 120, the springs 130, the tracks 141, the fixed mechanisms 150, and the surface 30 are disposed under a floor 50. A gap d is formed between the floor 50 and the base 20, and the machine 10 moves therein.

The present invention reduces vibration transmitted to a machine to protect the machine from damage. As well, the damper and the spring prevent the machine from colliding with other elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An anti-shock system for a machine, comprising:
a first movable device, disposed between the machine and a surface;
a damper disposed on the machine to absorb the vibration; and
a spring disposed on the machine to prevent the machine from colliding with other elements,
wherein when vibration is transmitted to the machine from the surface, the first movable device releases the machine, such that the machine slides on the surface.

2-3. (canceled)

4. The anti-shock system as claimed in claim 1, wherein the first movable device is a magnet.

5. The anti-shock system as claimed in claim 4, further comprising a damper disposed on the machine to absorb vibration.

6. The anti-shock system as claimed in claim 4, further comprising a spring disposed on the machine to prevent the machine from colliding with other elements.

7. The anti-shock system as claimed in claim 4, further comprising a second movable device disposed on the machine to guide the path of the machine.

8. The anti-shock system as claimed in claim 7, further comprising a damper disposed on the machine to absorb vibration.

9. The anti-shock system as claimed in claim 7, further comprising a spring disposed on the machine to prevent the machine from colliding with other elements.

10. The anti-shock system as claimed in claim 4, wherein the first movable device is an electromagnet.

11. The anti-shock system as claimed in claim 10, further comprising an anti-shock controller coupled with a machine controller, wherein when the machine controller shuts down the machine for vibration, the anti-shock controller directs the first movable device to release the machine.

12. The anti-shock system as claimed in claim 11, further comprising a damper disposed on the machine to absorb vibration.

13. The anti-shock system as claimed in claim 12, further comprising a spring disposed on the machine to prevent the machine from colliding with other elements.

14. The anti-shock system as claimed in claim 1, wherein the machine comprises four side surfaces.

15. The anti-shock system as claimed in claim 14, further comprising a plurality of dampers, disposed on a side surfaces to absorb vibration.

16. The anti-shock system as claimed in claim 14, further comprising a plurality of springs disposed on a side surfaces to prevent the machine from colliding with other elements.

17. The anti-shock system as claimed in claim 14, wherein the first movable device is an electromagnet.

18. The anti-shock system as claimed in claim 17, further comprising an anti-shock controller, coupled with a machine controller, wherein when the machine controller shuts down the machine for vibration, the anti-shock controller directs the first movable device to release the machine.

19. The anti-shock system as claimed in claim 14, further comprising a plurality of second movable devices disposed on a side surfaces to guide the path of the machine.

20. An anti-shock system for a machine comprising:
a first movable device, disposed between the machine and a surface;
a damper disposed on the machine to absorb the vibration;
a spring disposed on the machine to prevent the machine from colliding with other elements,
wherein when vibration is transmitted to the machine from the surface, the first movable device releases the machine, such that the machine slides on the surface; and
a base disposed between the first movable device and the machine to absorb vibration.

21-22. (canceled)

23. The anti-shock system as claimed in claim 20, further comprising a second movable device disposed on the base to guide the path of the machine.
